(19) United States
(12) Patent Application Publication
(10) Pub. No.: US 2025/0092889 A1
(43) Pub. Date: Mar. 20, 2025

(54) SYSTEMS AND METHODS FOR CLUTCH VALVE CLEANING

(71) Applicant: Dana Automotive Systems Group, LLC, Maumee, OH (US)

(72) Inventors: Aaron SHORT, Burbage (GB); Richard BARNBROOK, Cubbington (GB); Daniel HYETT, Nuneaton (GB)

(21) Appl. No.: 18/469,362

(22) Filed: Sep. 18, 2023

(51) Int. Cl. F15B 21/041; F16K 31/02

(52) U.S. Cl. CPC F15B 21/041; F16K 31/02

(57) ABSTRACT

Methods and systems are provided for cleaning a clutch valve of a closed clutch. In one example, a method comprising sending a valve cleaning control pulse to a valve in response to a clutch persisting in an engaged position and a clutch pressure demand within a threshold pressure range; and discontinuing the valve cleaning control pulse in response to detecting at least one exit condition.

### TECHNICAL FIELD

The present description relates generally to hydraulic actuation systems, and more particularly, to methods and systems for reducing build-up of contaminants in a clutch valve during operation of the clutch valve for an extended duration.

### BACKGROUND AND SUMMARY

In hydraulic actuation systems for clutches, contaminants, such as silt and detritus, can build up in a valve spool during certain conditions such as when the position of the valve remains constant for an extended duration or the valve experiences low flow for an extended duration. Prior valve cleaning strategies have involved cleaning the valve when the clutch is open, usually at the start or end of a drive cycle.

However, the inventors herein have recognized potential issues with such systems. As one example, the clutch valve may operate for extended periods without experiencing cleaning, especially when the vehicle is in a steady-state condition, such as at idle or during motorway driving. Further, while the clutch is closed and the range of motion of the clutch valve is limited, oil flow around the valve spool is stagnant. Low oil flow, limited clutch valve motion, and infrequent cleaning cycles increase opportunity for contaminant deposition, or silting, which may degrade the performance of the clutch over time.

In one example, the issues described above may be addressed by a method for valve cleaning comprising sending a valve cleaning control pulse to a valve in response to a clutch persisting in an engaged position and a clutch pressure demand within a threshold pressure range; and discontinuing the valve cleaning control pulse in response to detecting at least one exit condition. In this way, the clutch valve is cleaned during the drive cycle.

As one example, the at least one exit condition includes at least one of an anticipated clutch disengagement and the clutch pressure demand outside of the threshold pressure range. The valve cleaning control pulse may include shuttling the valve for a threshold duration. In one example, the valve cleaning control pulse comprises cyclically adjusting valve pressure between a first threshold and a second threshold for a first threshold duration. Pressure cycling the valve moves the valve spool at a high velocity up and down the stroke, producing a shaking effect which can dislodge detritus. Further, the action may increase oil flow rate through the valve thereby reducing the chance for contaminants in the oil to gather in or around the valve spool. In this way, the clutch is cleaned during the conditions where silting is most likely occur.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic representation of an example of a vehicle with a powertrain that includes a transmission system.

FIG. 2 shows a state machine illustrating a clutch cleaning model where transitions from a first state to a second state may be based on a clutch cleaning status and one or more sensor signals.

FIG. 3 shows a flow chart illustrating an exemplary closed clutch cleaning method.

FIG. 4 shows timing diagrams illustrating example prophetic operation of a closed clutch cleaning method.

### DETAILED DESCRIPTION

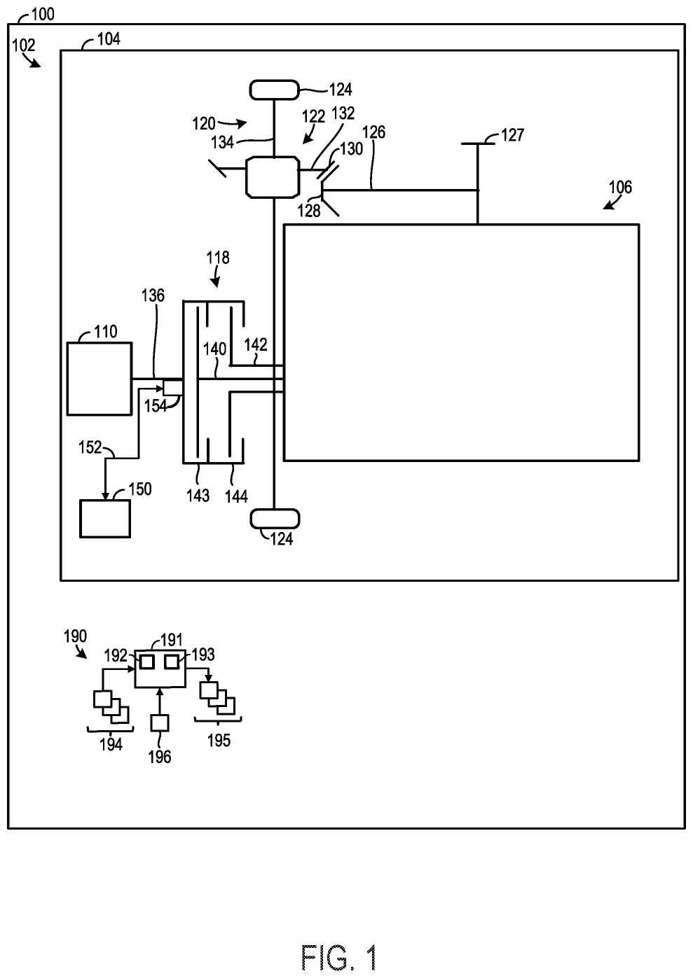

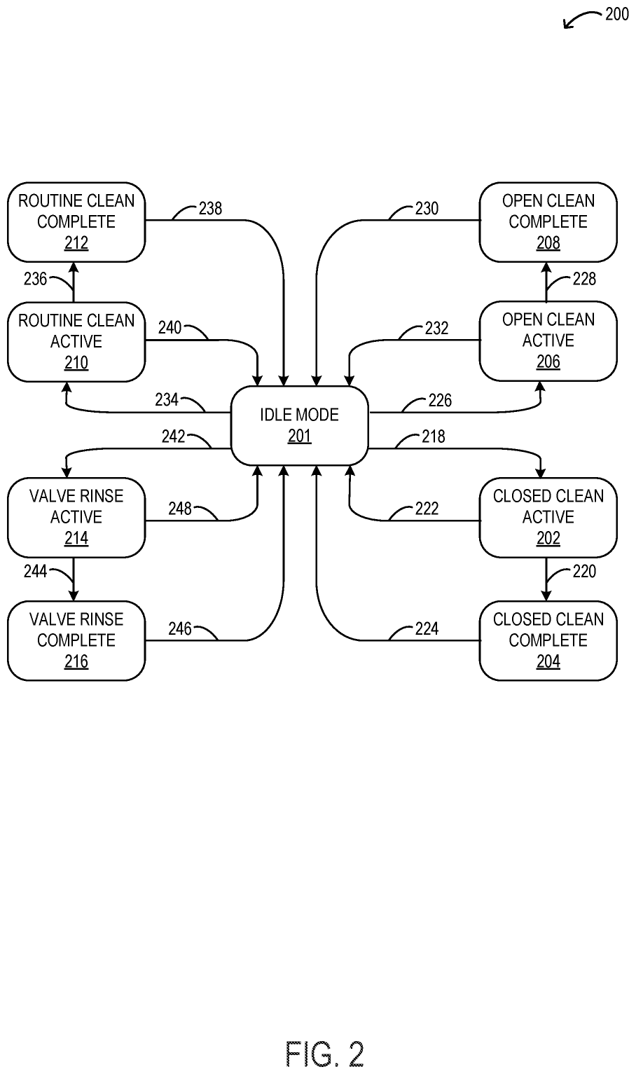

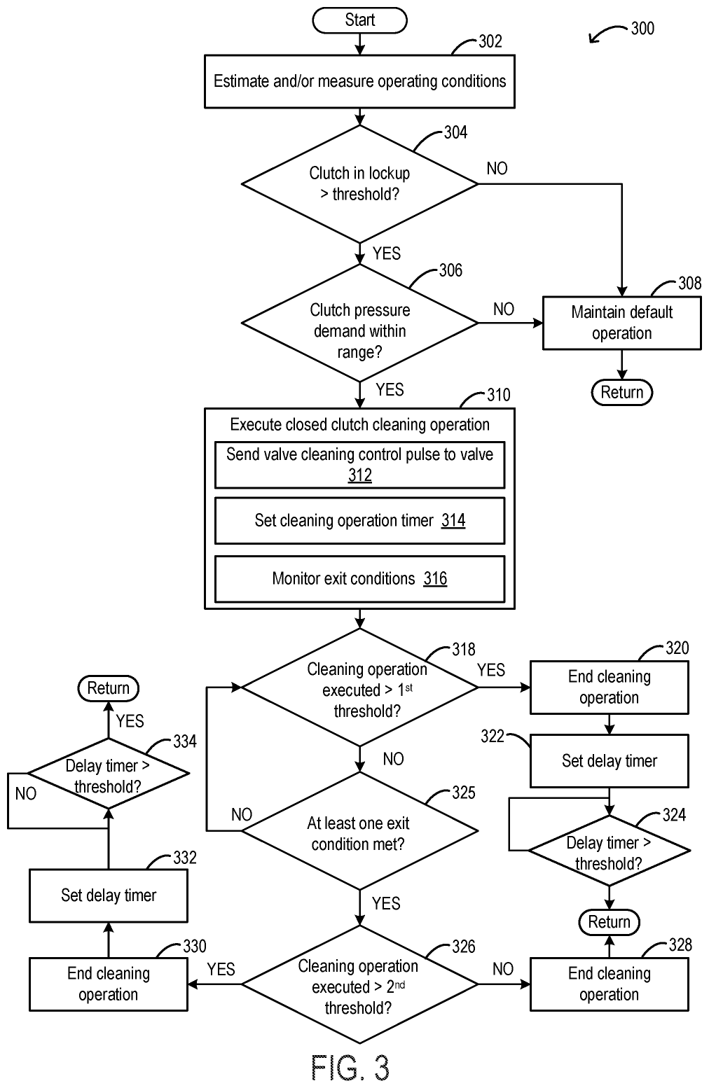

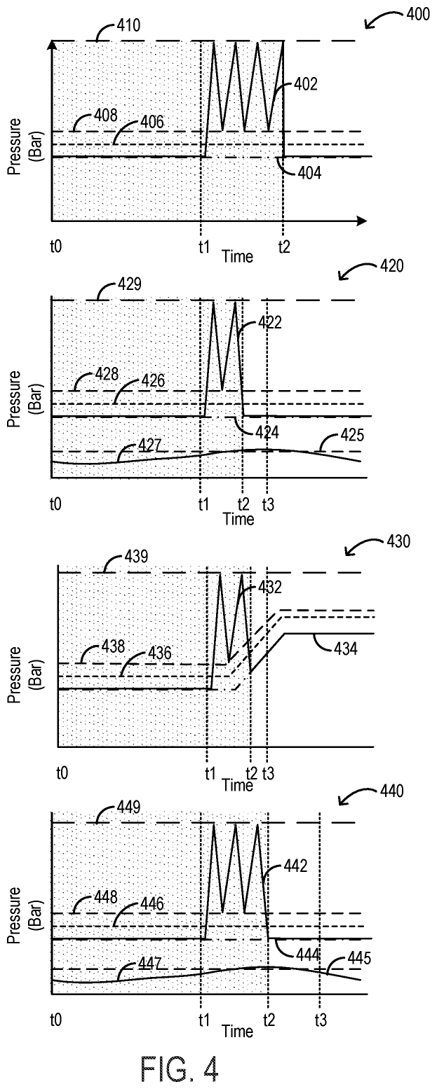

The following description relates to systems and methods for cleaning a valve of a clutch. In one example, the valve may be a spool valve controlling engagement of clutches in a dual-clutch transmission. In one example, a valve control strategy is proposed where the valve is shuttled using a sawtooth pattern when the clutch is in lockup torque control. In one example, lockup torque control is a clutch engagement condition wherein clutch torque is demanded above current engine torque to ensure there is no slip. The cleaning operation is exited if the clutch pressure drops out of a determined range, a component fault is detected, oil pressure, or line pressure drops below or exceeds threshold pressures. The shuttling of the valve in the sawtooth pattern moves the valve spool at a high velocity up and down the stroke, producing a shaking effect which can dislodge detritus, as well as increasing the flow rate through the spool which reduces the chance of “silting”, where sediment in the oil gathers in or around the spool to cause sticking. An example vehicle 100 including a dual-clutch transmission is shown in FIG. 1. A state diagram illustrating an example state machine 200 for controlling a clutch cleaning system to execute one or more exemplary clutch cleaning routines in a vehicle is shown in FIG. 2. FIG. 3 is a flow chart showing an exemplary method for controlling a clutch cleaning system. FIG. 4 shows timing diagrams illustrating prophetic examples of the disclosed methods for cleaning a closed clutch.

FIG. 1 shows a schematic depiction of a vehicle 100 with a powertrain 102 that includes a transmission system 104 with a multi-speed gearbox 106. The vehicle may take a variety of forms in different embodiments, such as a light, medium, or heavy duty vehicle for use in both on and/or off road driving environments. The powertrain 102, and specifically the transmission system 104, includes a prime mover, which may be an internal combustion engine or ICE 110 (e.g., a spark and/or compression ignition engine, hydrogen internal combustion engine, and the like). However, in other examples, the powertrain 102 may be adapted for use in a hybrid vehicle where the powertrain 102 is includes an ICE and an electric machine (e.g., a traction motor such as a motor generator). The ICE 110 may include conventional components such as cylinder(s), piston(s), valves, a fuel delivery system, an intake system, an exhaust system, and the like.

The transmission system 104 is illustrated as a dual-clutch transmission that includes a dual-clutch assembly 118, described in greater detail herein, although automated manual transmissions, manual transmissions, and full ICE transmissions have been envisioned and are described in greater detail herein. Thus, the dual-clutch assembly 118 may generally be referred to as a dual-clutch. Further, in other examples, the transmission system 104 may be included in a transaxle which includes an axle 120, a differential 122, and the transmission system 104 incorporated into one unit. In this way, the transmission may be adapted for use in a mid-engine vehicle or a front-engine vehicle. However, in other examples, the transmission, axle, and/or differential may be packaged as separate units.

The transmission system 104 includes the multi-speed gearbox 106 designed to shift between different discrete operating gears. The multi-speed gearbox 106 may be configured to transfer torque to drive wheels 124 via the differential 122 (e.g., axle differential). To elaborate, an output shaft 126 (e.g., pinion shaft) with a bevel gear 128 (e.g., a bevel pinion) meshing with a bevel gear 130 (e.g., crown gear) linked to the differential case (or carrier) 132 may be used to form the mechanical attachment between the gearbox and the differential, although other suitable types of gears may be used in other examples. In one example, the output shaft 126 may be a drive shaft. However, other suitable types of mechanical attachment may be used to couple the gearbox geartrain to the differential. Further, a drop gear 127 may be fixedly coupled (e.g., through a splined interface, a welded interface, other suitable connections, or combinations thereof) to the output shaft 126 and meshes with an output gear (not shown) of the multi-speed gearbox 106. The drive wheels 124 may be rotationally coupled to the differential via axle shafts 134 and/or other suitable mechanical components. Rotational axes of the axle shafts 134 may be arranged perpendicular to the rotational axes of the ICE 110, a first input shaft 140, a second input shaft 142, and/or the output shaft 126. Designing the transmission system in this manner may enable the system to be efficiently packaged in the vehicle and used in a wider variety of vehicles, in some instances. However, in alternate examples, the axle shafts may be arranged parallel to the ICE 110, the first input shaft 140, the second input shaft 142, and/or the output shaft 126. Further, the differential 122 may be any of an open differential, an electronic limited slip differential, a mechanical limited slip differential, and the like.

The ICE 110 may include an output shaft 136 that may be rotationally coupled to the dual-clutch assembly 118 in the transmission system 104. Further, the dual-clutch assembly 118 may selectively rotationally couple the output shaft 136 to a first input shaft 140 and a second input shaft 142. The first input shaft 140 may be an inner shaft and the second input shaft may be an outer input shaft coaxial with the first input shaft. To expound, the second input shaft 142 may be hollow and disposed concentrically about the first input shaft 140 or vice versa. In alternate embodiments the dual-clutch assembly may be replaced with a single clutch assembly for use in a manual transmission or an automated manual transmission, discussed in greater detail herein.

The dual-clutch assembly 118 may include a first clutch mechanism 143 and a second clutch mechanism 144, which may be wet or dry friction clutches. The first clutch mechanism 143 may include plates (e.g., friction plates and/or separator plates), and in some cases springs, which are engageable to transfer torque from the output shaft 136 to the first input shaft 140. As such, when the first clutch mechanism 143 is engaged, the output shaft 136 transfers torque to the first input shaft 140. Conversely, when the first clutch mechanism 143 is disengaged, mechanical power transfer through the clutch mechanism is inhibited. Similarly, the second clutch mechanism 144 may include plates (e.g., friction plates and/or separator plates), and in some cases springs, which are engageable to transfer torque from the output shaft 136 to the second input shaft 142. Thus, when the second clutch mechanism is engaged, the output shaft 136 transfers torque to the second input shaft and when the second clutch mechanism is disengaged torque transfer through the second clutch mechanism is inhibited. When the transmission system includes the dual-clutch assembly it may be referred to as a dual-clutch transmission system, in one example.

In one example, the dual-clutch assembly 118 includes a clutch actuator system with a spool valve, shown schematically, and hereinafter referred to as clutch actuator system 154. In one example, the spool valve of the clutch actuator system 154 is housed within a housing. A position of the spool valve within the housing may determine which of the first clutch mechanism 143 and the second clutch mechanism 144 is engaged or disengaged. The clutch actuator system 154 uses hydraulic fluid, which is maintained in a hydraulic system 150, shown schematically. The hydraulic system 150 may comprise one or more pumps to pressurize hydraulic fluid within a plurality of lines, shown schematically, and hereinafter referred to as lines 152. The position of the spool valve may be controlled by the clutch actuator system 154 in coordination with a controller 191 and the hydraulic system 150. For example, when adjustment of one of the first clutch mechanism 143 and the second clutch mechanism 144 is desired, the controller 191 sends a control signal to the clutch actuator system 154. In response, the clutch actuator system 154 adjusts the position of the spool valve based on the control signal. The position of the spool valve directs pressurized hydraulic fluid via lines 152 to a desired location in the clutch actuator system 154 so as to engage or disengage the selected clutch.

The multi-speed gearbox 106 may further include an additional shaft (not shown). Sets of gears may reside on the first input shaft 140, the second input shaft 142, and the additional shaft, respectively. Each of the sets of gears may include multiple gears therein. For example, one or more sets of gears on the first input shaft 140, and one or more sets of gears on the second input shaft, may mesh with a portion of the gears arranged on the additional shaft. In some examples, the gears arranged on the additional shaft that mesh with the gears on the first input shaft 140 may be referred to as odd gears. The gears arranged on the additional shaft that mesh with gears on or coaxial to the second input shaft 142 may be referred to as even gears. For example, engaging the first clutch mechanism 143 selectively couples the ICE 110 to the first input shaft 140 and one or more of the odd gears meshed therewith. Selectively engaging the second clutch mechanism 144 selectively couples the ICE 110 to the second input shaft 142 and one or more of the even gears meshed therewith.

The vehicle 100 may further include a control system 190 with the controller 191. The controller 191 includes a processor 192 and a memory 193. The memory 193 may hold non-transitory instructions stored therein that when executed by the processor cause the controller 191 to perform various methods, control techniques, and the like described herein. The processor 192 may include a microprocessor unit and/or other types of circuits. The memory 193 may include known data storage mediums such as random access memory, read only memory, keep alive memory, combinations thereof, and the like.

The controller 191 may receive various signals from sensors 194 (e.g., speed sensors, pressure sensors, clutch configuration sensors, temperature sensors, and the like) positioned in the vehicle 100 (e.g., the powertrain 102 and specifically the transmission system 104). Conversely, the controller 191 may send control signals to various actuators 195 at different locations in the vehicle and transmission system, for clutch engagement, gear shifting, electronic differential actuation, and the like, for instance, based on received signals and instructions stored in the memory 193 of the controller 191. For instance, the controller 191 may send command signals to the dual-clutch assembly 118 and/or the clutch actuator system 154. Responsive to the dual-clutch assembly 118 receiving the command signal, the clutch actuator system 154 may be used to shift the clutch to its engaged position, for example, by adjusting a position of the spool valve or other suitable clutch valve. The other controllable components in the transmission such as an electric pump, solenoid valves, and the like, and more generally the vehicle, may be operated in a similar manner with regard to sensor signals and actuator adjustment. The components that may be adjusted by the controller 191 may include the ICE 110, the differential 122 in the case of an electronic limited slip differential, other external devices/auxiliaries such as an air brake system and a suspension system, and the like. However, in other examples, separate controllers may adjust at least a portion of these controllable components.

Further, the controller 191 may be designed to execute instructions for cleaning a clutch valve, such as the spool valve of the clutch actuator system 154, discussed in greater detail herein. For instance, the controller 191 may to operate a clutch valve cleaning system, including adjusting hydraulic fluid to the clutch actuator system 154 via the hydraulic system 150 during execution of one or more clutch cleaning operations. For example, the clutch cleaning system may comprise a plurality of clutch cleaning routines that are executed in response to one or more operating conditions, such as routines that are executed when the clutch is disengaged, engaged, and/or in response to conditions such as reduced shifting quality, slipping, wear, and other faults. Exemplary clutch cleaning routines are described below and with reference with FIGS. 2-5.

One or more input device(s) 196 may be further included in the control system 190. The input devices 196 may include a gear selector that permits the vehicle operator to select an active gear from a group of drive gears and/or a forward, reverse, and neutral drive mode. The input devices 196 may further include a transmission system mode selector that permits the operator to select the vehicle's current operating mode from a group of operating modes. However, in other examples, more automated techniques for gear and/or drive mode selection may be used in the transmission system.

FIG. 2 shows a state diagram of an example state machine 200 representing a clutch cleaning system for a vehicle, such as described with reference to vehicle 100 of FIG. 1. The state machine 200 may use a control system, such as control system 190 of FIG. 1, and signals from sensors and/or actuators of the vehicle system, such as those described in FIG. 1. For example, the clutch cleaning system may comprise a plurality of clutch cleaning methods programmed as instructions on memory 193 of controller 191 of the control system 190 and executed by processor 192 in response to one or more operating conditions. The clutch cleaning system described by state machine 200 transitions between an idle state, a closed clean state, an open clean state, a routine clean state, and a valve rinse state. In the idle state, clutch cleaning is not occurring. In the open clean state, an open clutch cleaning operation may be executed by the clutch cleaning system. In the valve rinse state, a valve rinse cleaning operation may be executed by the clutch cleaning system. In the routine clean state, a routine cleaning operation may be executed by the clutch cleaning system. In the closed clean state, a closed clutch cleaning operation may be executed by the clutch cleaning system. Example closed clutch cleaning methods are described below and with reference to FIGS. 3-4. The state machine 200 may transition from one state to another based sensor signals and/or actuators indicating one or more operating conditions, such as a condition exceeding a threshold.

The clutch cleaning system may be considered to be operating in the idle state when the clutch cleaning system is operating with standard operating parameters, herein referred to as idle mode 201. The idle mode 201 may include all standard and typical behaviors of the vehicle system. In one example, the idle mode 201 includes the position of the valve not being oscillated. The clutch cleaning system may transition from the idle mode 201 to the open clean state, herein referred to as open clean active mode 206, based on detected disengagement of a clutch, represented by arrow 226. For example, disengagement of one of the first clutch mechanism 143 and the second clutch mechanism 144 of the dual-clutch assembly 118 in vehicle 100 may trigger the state machine 200 to transition from the idle mode 201 to the open clean active mode 206. In one example, the state machine 200 may transition from the idle mode 201 to the open clean active mode 206 in response to reducing or releasing hydraulic pressure applied to the clutch during clutch disengagement. For example, in the idle mode 201, clutch pressure reducing below a non-zero threshold pressure (e.g., 5 Bar) and a system depressure being requested may trigger transition to the open clean active mode 206.

The clutch cleaning system may be considered to be operating in the open clean active mode 206 when the clutch cleaning system is executing the open clean operation. In one example, the open clean operation may include a rapid, cyclical decrease and increase in valve pressure to remove line pressure and to clean the valve, also herein referred to as shuttling. For example, the open clean operation may include increasing the valve pressure to an upper threshold for a first duration (e.g., 19 Bar for 0.1 seconds) and subsequently reducing the valve pressure to a lower threshold (e.g., 0.1 Bar for 0.1 seconds) and repeating the cycle for a duration (e.g., 0.5 seconds). The clutch cleaning system may transition from the open clean active mode 206 to an open clean complete mode 208, based on detected completion of the open clean operation, represented by arrow 228. For example, an indication of the shuttling exceeding a threshold duration (e.g., 0.5 seconds) may trigger the state machine 200 to transition from the open clean active mode 206 to the open clean complete mode 208. The clutch cleaning system may transition from the open clean active mode 206 to the idle mode 201 based on detected incompletion of the open clean operation, represented by arrow 232. For example, the open clean operation may include one or more conditions that trigger the operation to abort. One such condition may include an indication of clutch engagement. For example, an indication of the clutch engagement prior to shuttling exceeding the threshold duration (e.g., 0.5 seconds) may trigger the state machine 200 to transition from the open clean active mode 206 to the idle mode 201. Other conditions may include an indication of a component fault or operating condition exceeding or depressure cancelled or hydraulic fluid temperature.

The clutch cleaning system may be considered to be operating in the open clean complete mode 208 when the clutch cleaning system has completed the open clean operation. The clutch cleaning system may transition from the open clean complete mode 208 to the idle mode 201, represented by arrow 230. In one example, the clutch cleaning system may transition from the open clean complete mode 208 to the idle mode 201 in response to the open clean operation reaching a threshold open clean time or a calibrated percentage of the threshold open clean time has passed and a clean abort request is triggered.

The clutch cleaning system may transition from the idle mode 201 to the routine clean state, herein referred to as routine clean active mode 210, based on a detected universal diagnostic system (UDS) clutch cleaning system request of a routine clean, represented by arrow 234. In some examples, routine clean may be requested periodically, such as part of a standard operating procedure. In other examples, routine clean may be requested in response to operating conditions exceeding or reducing below a threshold. In most examples, routine clean is called by the UDS routine being called by the relevant UDS tool. For example, the clutch cleaning system routine clean may trigger the state machine 200 to transition from the idle mode 201 to the routine clean active mode 210 in response to an indication of a stuck valve.

The clutch cleaning system may be considered to be operating in the routine clean active mode 210 when the clutch cleaning system is executing a routine clean. In one example, the routine clean may be the same or similar to the open clean operation, including, for example, shuttling the valve between 0 and 19 Bar to recover a stuck valve. Similarly, as above, the routine clean may include increasing the valve pressure to an upper threshold for a first duration (e.g., 19 Bar for 0.1 seconds) and subsequently reducing the valve pressure to a lower threshold (e.g., 0.1 Bar for 0.1 seconds) and repeating the cycle for a duration (e.g., 0.5 seconds). The clutch cleaning system may transition from the routine clean active mode 210 to the routine clean complete mode 212, based on detected completion of the routine clean, represented by arrow 236. For example, an indication of the shuttling exceeding a threshold duration (e.g., 0.5 seconds) may trigger the state machine 200 to transition from the routine clean active mode 210 to the routine clean complete mode 212. The clutch cleaning system may transition from the routine clean active mode 210 to the idle mode 201 based on detected incompletion of the routine clean, represented by arrow 240. For example, the routine clean may include one or more conditions that trigger the operation to abort. One such condition may include an indication of a component fault or operating condition exceeding or decreasing below a threshold, such as abnormal line pressure or hydraulic fluid temperature.

The clutch cleaning system may be considered to be operating in the routine clean complete mode 212 when the clutch cleaning system has completed the routine clean. The clutch cleaning system may transition from the routine clean complete mode 212 to the idle mode 201, represented by arrow 238. In one example, the clutch cleaning system may transition from the routine clean complete mode 212 to the idle mode 201 in response to the routine clean operation reaching a threshold routine clean time without any abort requests.

The clutch cleaning system may transition from the idle mode 201 to the valve rinse state, herein referred to as valve rinse active mode 214, based on detected clutch cleaning system request of a valve rinse, represented by arrow 242. In some examples, a valve rinse may be requested periodically such as part of a standard operating procedure. Further, a valve rinse may be requested in response to operating conditions exceeding or reducing below a threshold. For example, the valve rinse may be requested when the valve is in a pre-fill or default state, e.g., not controlling hydraulic fluid flow, for greater than a threshold duration. In one example, the valve rinse may be requested to move silt and reduce valve sticking. For example, the clutch cleaning system may trigger the state machine 200 to transition from the idle mode 201 to the valve rinse active mode 214 in response to an indication of a stuck valve.

The clutch cleaning system may be considered to be operating in the valve rinse active mode 214 when the clutch cleaning system is executing a valve rinse. In one example, the valve rinse may include increasing an amplitude of a dither of the valve and reducing the dither frequency to temporarily increase the stroke and spool force. In some examples, valve rinsing may be implemented as a less aggressive means of reducing the chances of valve silting, as well as an approach to unstick a potentially stuck valve. Because it only changes the dither and not the actual root mean square (RMS) current it can be used on a controlling clutch without effecting the pressure response too much. As mentioned, it is not as aggressive or effective at shifting silting or unsticking as a valve clean. The clutch cleaning system may transition from the valve rinse active mode 214 to the valve rinse complete mode 216, based on detected completion of the valve rinse operation, represented by arrow 244. For example, an indication of the valve rinse exceeding a threshold duration (e.g., 0.5 seconds) may trigger the state machine 200 to transition from the valve rinse active mode 214 to the valve rinse complete mode 216. The clutch cleaning system may transition from the valve rinse active mode 214 to the idle mode 201 based on detected incompletion of the valve rinse operation, represented by arrow 248. For example, the valve rinse operation may include one or more conditions that trigger the operation to abort. One such condition may include an indication of a component fault or operating condition exceeding or decreasing below a threshold, such as abnormal line pressure or hydraulic fluid temperature.

The clutch cleaning system may be considered to be operating in the valve rinse complete mode 216 when the clutch cleaning system has completed the valve rinse operation. The clutch cleaning system may transition from the valve rinse complete mode 216 to the idle mode 201, represented by arrow 246. In one example, the clutch cleaning system may transition from the valve rinse complete mode 216 to the idle mode 201 in response to the valve rinse operation reaching a threshold valve rinse time or a calibrated percentage of the valve rinse time has passed and a rinse abort request is triggered.

The clutch cleaning system may transition from the idle mode 201 to the closed clean state, herein referred to as a closed clean active mode 202, based on detected clutch engagement, and a clutch pressure demand within a target range, represented by arrow 218. For example, the clutch pressure target range may be a pressure calibrated to maintain clutch torque above the current engine torque demand to eliminate slip. For example, the clutch pressure target is set well above the pressure required to maintain the usual operating (micro) slip range. For example, (micro) slip range may be a clutch pressure equivalent to maintaining clutch torque demand that is 25 revolutions-per-minute (RPM) greater than the engine torque. In other words, the closed clean active mode 202 may be requested in response to detected clutch engagement in lockup torque control over a threshold duration. As one example, engagement of one of the first clutch mechanism 143 and the second clutch mechanism 144 of the dual-clutch assembly 118 in vehicle 100 for greater than a threshold duration and within the target pressure range may trigger the state machine 200 to transition from the idle mode 201 to the closed clean active mode 202

The clutch cleaning system may be determined to be operating in the closed clean active mode 202 when the clutch cleaning system is executing the closed clean operation. In one example, the closed clean operation may include a clutch cleaning operation comprising a rapid, cyclical decrease and increase in valve pressure, e.g., shuttling, within an upper threshold and a lower threshold based on the clutch pressure demand from the torque to pressure controller. For example, the closed clean operation may include adjusting the valve pressure to a first threshold pressure for a first duration and then to a second threshold pressure for a second direction and repeating the cycle for a third threshold duration. In one example, the first threshold pressure is different from the second threshold pressure, the first duration is equal or different from the second duration, and the third threshold duration is greater than the first duration and the second duration. The clutch cleaning system may transition from the closed clean active mode 202 to a closed clean complete mode 204, based on detected completion of the closed clean operation, represented by arrow 220. For example, an indication of the shuttling exceeding the first threshold duration (e.g., 0.5 seconds) may trigger the state machine 200 to transition from the closed clean active mode 202 to the closed clean complete mode 204. The clutch cleaning system may transition from the closed clean active mode 202 to the idle mode 201 based on detected incompletion of the closed clean operation, represented by arrow 222. For example, the closed clean operation may include one or more conditions that trigger the operation to abort. Example conditions may include anticipation of clutch disengagement, clutch pressure increasing above or reducing below the target range, oil temperature exceeding a threshold, or detected fault condition. For example, an indication of the clutch disengagement prior to shuttling exceeding a second threshold duration (e.g., 0.2 seconds) may trigger the state machine 200 to transition from the closed clean active mode 202 to the idle mode 201.

The clutch cleaning system may be considered to be operating in the closed clean complete mode 204 when the clutch cleaning system has completed the closed clean operation. The clutch cleaning system may transition from the closed clean complete mode 204 to the idle mode 201, represented by arrow 224. For example, the clutch cleaning system may transition from the closed clean complete mode 204 to the idle mode 201 in response to the closed clutch cleaning operation reaching a threshold closed clean time or a calibrated percentage of the threshold closed clean time has passed and a clean abort request is triggered.

FIG. 3 shows a flow chart for a method 300. The method 300 is one example of the disclosed methods for cleaning a closed clutch. In particular, the method 300 may be an approach for cleaning a clutch valve controlling clutch mechanisms in a dual-clutch transmission, such as the dual-clutch assembly 118 describe above with reference to FIG. 1. Instructions for carrying out the method 300 may be executed by a controller based on instructions stored on a memory of the controller and in conjunction with signals received from sensors of the vehicle system, such as the controller 191, the memory 193, and the sensors 194 described above with reference to FIG. 1. The controller may employ actuators of the vehicle system to adjust vehicle operation, such as the clutch actuator system 154 and the actuators 195 described above with reference to FIG. 1, according to the methods described below.

At 302, the method 300 includes estimating and/or measuring operating conditions. For example, operating conditions may include engagement status of one or more clutches (e.g., the first clutch mechanism 143, the second clutch mechanism 144 in FIG. 1), and additionally or alternatively, may further include a duration of engagement/disengagement of the one or more clutches. The operating conditions may include one or more of a clutch pressure demand, a clutch torque demand, an engine torque demand, oil temperature, oil pressure, hydraulic line pressure, and/or fault condition(s) of one or more transmission components such as a clutch valves, sensor(s), and others.

At 304, the method 300 includes determining whether a clutch is closed (engaged) and in lockup torque control is over threshold duration. In one example, the threshold duration may be a non-zero positive value threshold, such as 0.5 seconds. In response to determining the clutch is not closed for greater than the threshold duration, the method 300 may maintain default operation at 308. For example the method 300 may maintain default operation in response to determining the clutch is open or in response to determining the clutch is in lockup torque control for a duration less than or equal to the threshold duration.

In response to determining the clutch is in lockup torque control for greater than the threshold duration, the method 300 may include determining whether the clutch pressure demand is within a threshold range at 306. In one example, the threshold range may comprise a lower threshold and an upper threshold, which may each be non-zero positive value thresholds. In one example, the threshold range is a fixed range that is calibrated for different applications. In one example the threshold range may be 4-16 Bar. In response to determining the clutch pressure is not within the threshold range, the method 300 may maintain default operation at 308. Thus, the method 300 determines the conditions of the duration of the clutch in lockup torque control and if the clutch pressure is within a threshold range prior to executing the closed clutch cleaning operation. For example, in a situation where the clutch is closed and pressure is not within the threshold range, the method may include maintaining default operation at 308 and returning to the start of method 300. In this way, the system may continue monitoring for the conditions that trigger a closed clutch cleaning operation.

In response to determining the clutch pressure demand is within the threshold range, the method 300 may include executing a closed clutch cleaning operation at 310. The closed clutch cleaning operation may include sending a valve cleaning control pulse to an actuator of the clutch valve at 312. The closed clutch cleaning operation may further include setting a cleaning operation timer at 314. The closed clutch cleaning operation may further include monitoring exit conditions at 316.

For example, the valve cleaning control pulse sent at 312 may be the same or similar to the valve cleaning control pulse described with reference to FIGS. 2-3. The controller may determine a control signal to send to the clutch valve, such as a pulse width of the signal being determined based on a first clutch pressure threshold and a second clutch pressure threshold. For example, the first clutch pressure threshold may be a positive, non-zero pressure threshold that is calibrated to maintain the clutch pressure above the nominal pressure for the engine torque demand. The second clutch pressure threshold may be a positive, non-zero pressure threshold that is calibrated to maintain an appropriate line pressure in the hydraulic system. In one example, the valve cleaning control pulse moves the valve spool at a high velocity up and down the stroke, producing a shaking effect which can dislodge any detritus as well as increasing the flow rate through the valve spool. The cleaning operation timer at 314 may be set to a first threshold duration. In one example, the first threshold duration a dynamic value based on an anticipated dirtiness of the valve based on operation, previous cleaning, and previous cleaning duration. Alternatively, the first threshold duration may be based on a fixed value empirically determined to fully clean the valve. In one example, a clean valve is a valve with a soot/debris load less than a threshold load (e.g., 5% or less load) and a dirty valve is a valve with a soot/debris load greater than or equal to the threshold load. For example, when the valve is cleaned, the valve is returned to a less loaded condition. In one example, the controller may determine a control signal to send to a countdown timer of the vehicle system determined based on the first threshold duration. For example, the first threshold duration may be 0.5 seconds. During the valve cleaning control pulse, exit conditions may be monitored at 316 including, but not limited to, one or more of anticipated clutch disengagement, clutch pressure demand outside of the threshold range, oil temperature exceeding a threshold, hydraulic line pressure exceeding a threshold, fault detection. In one example, the exit conditions may be early exit conditions that cause the clutch cleaning operation to abort before the first threshold duration, whereas the first threshold duration causes the clutch cleaning operation to abort due to the procedure completion.

At 316, the method 300 may include determining whether the clutch cleaning operation is executed for greater the first threshold duration. In response to determining the cleaning operation executed for greater than the first threshold duration, the method 300 may include ending the closed clutch cleaning operation at 320. In response to determining the cleaning operation has not executed for greater than the first threshold duration, the method 300 may include determining whether at least one exit condition is met at 325. In response to determining at least one exit condition is not met, the method 300 may return to 318.

At 320, ending (or discontinuing) the closed clutch cleaning operation may include adjusting the clutch pressure demand to the clutch pressure calibrated to maintain the engine torque demand. For example, the controller may determine a control signal to send to the clutch valve, such as a pulse width of the signal determined based on the engine torque demand.

At 322, the method 300 may include setting a delay timer. In one example, the delay timer may be set to introduce a delay before initiating a closed clutch cleaning operation (e.g., another a closed clutch cleaning operation). For example, the delay timer may prevent execution of a closed clutch cleaning operation until a threshold time interval has elapsed. In one example, the controller may determine a control signal to a delay timer of the vehicle system determined based on the threshold time interval. In one example, the threshold time interval may be a non-zero, positive-value threshold duration of time. For example, the threshold time interval may be calibrated based on one or more conditions of the hydraulic system, the clutch, the clutch valve, and/or other parameters. In one example, the threshold time interval may be 600 seconds.

At 324, the method 300 may include determining whether the delay has exceeded the threshold time interval. In response to determining the delay timer has exceeded the threshold time interval, the method 300 may return.

Returning to 325, in response to determining at least one exit condition is met, the method 300 may include determining whether the closed clutch cleaning operation executed for greater than a second threshold duration at 326. In one example, the second threshold duration may be non-zero, positive threshold duration of time, which may be shorter than the first threshold duration but sufficient to dislodge detritus from the clutch valve. For example, the second threshold duration may be 30% of the first threshold duration or 0.2 seconds. In response to determining the cleaning operation has not executed for greater than the second threshold duration, the method 300 may include ending the cleaning operation at 328 and returning. By returning in response to cleaning operation aborting early and without sufficient duration, the closed clutch cleaning operation may initiate in response to detection of the aforementioned operating conditions without delay.

In response determining the closed clutch cleaning operation executed for greater than the second threshold duration, the method 300 may include ending the closed clutch cleaning operation at 330. As above, in one example, ending the closed clutch cleaning operation may include adjusting the clutch pressure demand to the nominal clutch pressure for the engine torque demand.

At 332, the method 300 may include setting the delay timer.

At 334, the method 300 may include determining whether the delay timer has exceeded the threshold time interval. In one example, the threshold time interval may the same or similar to the threshold time interval described above, such as, 600 seconds. In response to determining the delay timer has exceeded the threshold time interval, the method 300 may return.

FIG. 4 illustrates timing diagrams 400, 420, 430, 440 showing a sequence of actions performed within a method for cleaning a clutch valve of a closed clutch for an exemplary vehicle system. In particular, the method may be an approach for cleaning a clutch valve controlling clutch mechanisms in a dual-clutch transmission, such as the first clutch mechanism 143 and the second clutch mechanism 144 of dual-clutch assembly 118 describe above with reference to vehicle 100 of FIG. 1. The method for cleaning a clutch valve may be the same as or similar to the series of actions described above with reference to the method 300 in FIG. 3. Instructions for performing the method described in timing diagrams 400, 420, 430, 440 may be executed by a controller (e.g., controller 191) based on instructions stored on a memory of the controller and in conjunction with sensory feedback received from components from the vehicle transmission system (e.g., sensors 194) described above with reference to FIG. 1. In the prophetic examples, the controller determines whether entry conditions are indicated. If entry conditions are indicated, a clutch valve cleaning control pulse may be generated to execute a closed clutch cleaning operation. The pressure demand and sensor feedback is monitored throughout the cleaning operation. If one or more exit conditions are indicated, the controller aborts the cleaning operation. Timing diagram 400 depicts a scenario wherein the cleaning operation is executed for the first threshold duration. Timing diagram 420 depicts a scenario wherein the cleaning operation is aborted in response to detecting a first exit condition. Timing diagram 430 depicts a scenario wherein the cleaning operation is aborted in response to detecting a second exit condition. Timing diagram 440 depicts a scenario wherein the cleaning operation is executed for a second threshold duration. The horizontal (x-axis) denotes time and the vertical markers t0-t3 identify relevant times in timing diagrams 400, 420, 430, 440 for cleaning a closed clutch. Stipple shading represents periods of the timing diagrams 400, 420, 430, 440 wherein entry conditions are indicated for executing the closed clutch cleaning operation.

Timing diagram 400 shows plots 402, 404, 406, 408, 410 which illustrate states of components and/or control settings of the vehicle system over time. Plot 402 indicates a clutch valve pressure demand. Generating a valve clean request may rapidly increase and decrease the clutch valve pressure demand between a first clutch pressure threshold and a second clutch pressure threshold, which appears as a sawtooth pattern in the valve pressure request signal. In other words, the pressure oscillates, or zigzags, between the first clutch pressure threshold and the second clutch pressure threshold. Plot 404 shows a nominal clutch pressure threshold, which may be a clutch pressure calibrated to maintain an engine torque request. Plot 406 and plot 408 show a clutch minimum pressure overhead and a clutch maximum pressure overhead, respectively, which may represent a low pressure threshold range during the closed clutch valve cleaning request. For example, during the valve clean request, the first clutch pressure threshold may be set to the clutch maximum pressure overhead. The valve clean request may abort early in response to the system detecting clutch valve pressure demand below the minimum pressure overhead. Plot 410 shows an upper pressure threshold, which may be the second clutch pressure threshold of the valve cleaning request. For example, a sensor signal indicating clutch valve pressure demand exceeding the second clutch pressure threshold may cause the valve clean request to abort early.

At t0, plot 404 indicates the nominal clutch pressure, e.g., 12 Bar, to maintain the clutch (e.g., the first clutch mechanism 143 in FIG. 1) in a closed position at a current engine torque demand. Clutch valve pressure demand, as shown by plot 402, is substantially similar to the nominal clutch pressure threshold. Plot 410 indicates the upper pressure threshold, e.g., 20 Bar, as detected by one of sensors 194 in the hydraulic system 150.

From t0 to t1, the clutch remains engaged as shown by plot 402 overlapping with plot 404.

At t1, the conditions are met to execute the closed clutch cleaning operation. For example, the clutch is engaged and in lockup torque control for greater than a threshold duration, e.g., from t0 to t1, and the clutch valve pressure demand is within a target range, e.g., between 4 Bar and 16 Bar.

From t1 to t2, the system executes the closed clutch cleaning operation. The clutch valve pressure demand, as shown by plot 402, cyclically increases up to the second pressure threshold, shown by plot 410, and decreases down to the first pressure threshold, as shown by plot 408, which appears as the aforementioned sawtooth pattern. During the closed clutch cleaning operation, the system monitors exit conditions. As one example, the exit conditions may include monitoring the clutch valve pressure demand, as shown by plot 402, and whether the clutch valve pressure demand is outside of the target range, e.g., greater than the second threshold, as shown by plot 410, or less than the first threshold, as shown by plot 406.

At t2, the closed clutch cleaning operation exceeds a first threshold duration, e.g., from t1 to t2. In one example, t1 to t2 may represent 0.4 seconds. Therefore at t2, the closed clutch cleaning operation is ended and the clutch valve pressure demand is adjusted to the nominal clutch pressure to maintain the clutch in the closed position at the current engine torque demand.

Timing diagram 420 shows plots 422, 424, 426, 428, 429, which illustrate states of components and/or control settings of the vehicle system over time. Plot 422 indicates the clutch valve pressure demand. Plot 424 shows the nominal clutch pressure threshold. Plot 426 and plot 428 show the clutch minimum pressure overhead and the clutch maximum pressure overhead, respectively. Plot 429 shows the upper pressure threshold. In the example, plots 422, 424, 426, 428, 429 may be determined similarly as described with reference to timing diagram 400. Further, plots 422, 424, 426, 428, 429 may control execution of the closed clutch cleaning operation similarly as described with reference to timing diagram 400. Timing diagram 420 further includes an exit condition threshold shown by plot 425 and an exit condition sensor shown by plot 427. During a closed clutch cleaning operation, the system may receive signals from the exit condition sensor and, in response to the sensor signal indicating an exit condition exceeding the exit condition threshold, the system may end the closed clutch cleaning operation. In the example, the exit condition threshold may be a threshold oil temperature and the exit condition sensor may be an oil temperature sensor.

At t0, plot 424 indicates the nominal clutch pressure, e.g., 12 Bar, to maintain the clutch in a closed position at a current engine torque demand. Clutch valve pressure demand, as shown by plot 422, is substantially similar to the nominal clutch pressure threshold. Plot 429 indicates the upper pressure threshold, e.g., 20 Bar, as detected by one of sensors 194 in the hydraulic system.

From t0 to t1, the clutch remains engaged as shown by plot 422 overlapping with plot 424.

At t1, the conditions are met to execute the closed clutch cleaning operation. For example, the clutch is engaged and in lockup torque control for greater than a threshold duration, e.g., from t0 to t1, and the clutch valve pressure demand is within the target range, e.g., between 4 Bar and 16 Bar.

From t1 to t2, the system executes the closed clutch cleaning operation. The clutch valve pressure demand, as shown by plot 422, cyclically increases up to the second pressure threshold, shown by plot 429, and decreases down to the first pressure threshold, as shown by plot 428. During the closed clutch cleaning operation, the system monitors exit conditions including receiving signals from the oil temperature sensor, as shown by plot 427. As time approaches t2, the oil temperature sensor indicate oil temperature approaching the oil temperature threshold, as shown by plot 425.

At t2, the system detects at least one exit condition. In the example, the oil temperature sensor indicates the oil temperature has exceeded the oil temperature threshold. Therefore at t2, the closed clutch cleaning operation is aborted and the clutch valve pressure demand is adjusted to the nominal clutch pressure to maintain the clutch in the closed position at the current engine torque demand. In the example, t1 to t2 is less than a second threshold duration, shown by t1 to t3, therefore the clutch cleaning operation may initiate in response the entry conditions being met without a delay interval. In one example, t1 to t3 may represent 0.2 seconds.

Timing diagram 430 shows plots 432, 434, 436, 438, 439, which illustrate states of components and/or control settings of the vehicle system over time. Plot 432 indicates the clutch valve pressure demand. Plot 434 shows the nominal clutch pressure threshold. Plot 436 and plot 438 show the clutch minimum pressure overhead and the clutch maximum pressure overhead, respectively. Plot 439 shows the upper pressure threshold. In the example, plots 432, 424, 436, 438, 439 may be determined similarly as described with reference to timing diagram 400. Further, plots 432, 434, 436, 438, 439 may control execution of the closed clutch cleaning operation similarly as described with reference to timing diagram 400.

At t0, plot 434 indicates the nominal clutch pressure, e.g., 12 Bar, to maintain the clutch in a closed position at a current engine torque demand. Clutch valve pressure demand, as shown by plot 432, is substantially similar to the nominal clutch pressure threshold. Plot 439 indicates the upper pressure threshold, e.g., 20 Bar, as detected by one of sensors 194 in the hydraulic system.

From t0 to t1, the clutch remains engaged as shown by plot 432 overlapping with plot 434.

At t1, the conditions are met to execute the closed clutch cleaning operation. For example, the clutch is engaged and in lockup torque control for greater than a threshold duration, e.g., from t0 to t1, and the clutch valve pressure demand is within the target range, e.g., between 4 Bar and 16 Bar.

From t1 to t2, the system executes the closed clutch cleaning operation. As shown previously, the clutch valve pressure demand shuttles between the first pressure threshold and the second pressure threshold, shown by plot 438 and plot 439, respectively, while the system monitors exit conditions. As time approaches t2, one of sensors 194 indicate increasing nominal clutch pressure demand, shown by plot 434.

At t2, the system detects at least one exit condition. In the example, the increasing nominal clutch pressure demand causes the closed clutch cleaning operation to abort. Therefore at t2, the clutch valve pressure demand is adjusted to the nominal clutch pressure, shown by 434, to maintain the clutch in the closed position at the current engine torque demand. In the example, t1 to t2 is less than the second threshold duration, shown by t1 to t3, therefore the clutch cleaning operation may initiate in response the entry conditions being met without a delay interval. In one example, t1 to t3 may represent 0.2 seconds.

Timing diagram 440 shows plots 442, 444, 446, 448, 449, which illustrate states of components and/or control settings of the vehicle system over time. Plot 442 indicates the clutch valve pressure demand. Plot 444 shows the nominal clutch pressure threshold. Plot 446 and plot 448 show the clutch minimum pressure overhead and the clutch maximum pressure overhead, respectively. Plot 449 shows the upper pressure threshold. In the example, plots 442, 444, 446, 448, 449 may be determined similarly as described with reference to timing diagram 400. Further, plots 442, 444, 446, 448, 449 may control execution of the closed clutch cleaning operation similarly as described with reference to timing diagram 400. Timing diagram 440 further includes an exit condition threshold shown by plot 445 and an exit condition sensor shown by plot 447, which may be the threshold oil temperature and the oil temperature sensor, respectively, described with reference to timing diagram 420.

At t0, plot 444 indicates the nominal clutch pressure, e.g., 12 Bar, to maintain the clutch in a closed position at a current engine torque demand. Clutch valve pressure demand, as shown by plot 422, is substantially similar to the nominal clutch pressure threshold. Plot 449 indicates the upper pressure threshold, e.g., 20 Bar, as detected by one of sensors 194 in the hydraulic system.

From t0 to t1, the clutch remains engaged as shown by plot 442 overlapping with plot 444.

At t1, the conditions are met to execute the closed clutch cleaning operation. For example, the clutch is engaged and in lockup torque control for greater than a threshold duration, e.g., from t0 to t1, and the clutch valve pressure demand is within the target range, e.g., between 4 Bar and 16 Bar.

From t1 to t2, the system executes the closed clutch cleaning operation. The clutch valve pressure demand, as shown by plot 422, cyclically increases up to the second pressure threshold, shown by plot 449, and decreases down to the first pressure threshold, as shown by plot 448. During the closed clutch cleaning operation, the system monitors exit conditions including receiving signals from the oil temperature sensor, as shown by plot 447. As time approaches t2, the oil temperature sensor indicates oil temperature approaching the oil temperature threshold, as shown by plot 445.

At t2, the system detects at least one exit condition. In the example, the oil temperature sensor indicates the oil temperature has exceeded the oil temperature threshold. Therefore at t2, the closed clutch cleaning operation is aborted and the clutch valve pressure demand is adjusted to the nominal clutch pressure to maintain the clutch in the closed position at the current engine torque demand. In the example, t1 to t2 is greater than a second threshold duration. The second threshold duration may be shorter than the first threshold duration but sufficient to dislodge detritus from the clutch valve, e.g., 0.2 seconds. Therefore, a delay timer is set at an interval from t2 to t3.

From t2 to t3, a countdown timer measuring the delay interval prevents the system from initiating a closed clutch cleaning operation.

At t3, the delay interval ends and the system monitors for entry conditions to initiate the closed clutch cleaning operation.

In this way, a clutch valve is automatically cleaned for a closed clutch. By initiating a clutch valve cleaning operation when the clutch is in lockup torque control, the clutch valve is cleaned during steady state driving, including conditions where valve movement is reduced and/or hydraulic flow through the valve is reduced, conditions where contaminant buildup is most likely to occur in the clutch valve. The technical effect of the disclosed systems and methods is increasing a frequency of clutch valve cleaning, which may reduce buildup of contaminants that may otherwise contribute to clutch degradation and/or reduced performance.

The disclosure also provides support for a method, comprising: sending a valve cleaning control pulse to a valve in response to a clutch persisting in an engaged position and a clutch pressure demand within a threshold pressure range, and discontinuing the valve cleaning control pulse in response to detecting at least one exit condition. In a first example of the method, the at least one exit condition comprises at least one of a clutch disengagement is anticipated and the clutch pressure demand is outside of the threshold pressure range. In a second example of the method, optionally including the first example, the at least one exit condition comprises an oil temperature exceeding an upper threshold or below a lower threshold. In a third example of the method, optionally including one or both of the first and second examples, the at least one exit condition comprises detecting a component fault. In a fourth example of the method, optionally including one or more or each of the first through third examples, the clutch persisting in the engaged position comprises a clutch torque demand above a current engine torque. In a fifth example of the method, optionally including one or more or each of the first through fourth examples, the clutch comprises one of a first clutch mechanism and a second clutch mechanism of a dual-clutch transmission. In a sixth example of the method, optionally including one or more or each of the first through fifth examples, the valve is a spool valve. In a seventh example of the method, optionally including one or more or each of the first through sixth examples, the valve cleaning control pulse comprises cyclically adjusting a valve pressure between a first threshold and a second threshold for a second threshold duration. In a eighth example of the method, optionally including one or more or each of the first through seventh examples, the method further comprises: discontinuing the valve cleaning control pulse in response to the valve cleaning control pulse exceeding the second threshold duration, and setting a delay timer. In a ninth example of the method, optionally including one or more or each of the first through eighth examples, the delay timer is set for 600 seconds.

The disclosure also provides support for a system, comprising: a transmission configured to rotationally couple a prime mover to a drive shaft, a first input shaft coupled to the transmission, a second input shaft coupled to the transmission, a dual-clutch assembly comprising a first clutch mechanism and a second clutch mechanism, the first clutch mechanism and the second clutch mechanism selectively coupling one of the first input shaft and the second input shaft, respectively, to the prime mover in response to a clutch pressure demand, a valve configured to control a flow of hydraulic fluid to the dual-clutch assembly, and a controller including non-transitory instructions stored in memory executable to: send a valve cleaning control pulse to the valve in response to detection of one of the first clutch mechanism and the second clutch mechanism persisting in an engaged position for a first threshold duration and the clutch pressure demand within a threshold pressure range, and discontinue the valve cleaning control pulse in response to detection of at least one exit condition. In a first example of the system, the valve is a spool valve. In a second example of the system, optionally including the first example, the first input shaft is an inner shaft and the second input shaft is an outer input shaft coaxial with the first input shaft. In a third example of the system, optionally including one or both of the first and second examples, the at least one exit condition comprises at least one of clutch disengagement is anticipated and the clutch pressure demand is outside of the threshold pressure range. In a fourth example of the system, optionally including one or more or each of the first through third examples, the valve cleaning control pulse comprises cyclically adjusting a valve pressure between a first threshold and a second threshold for a second threshold duration.

The disclosure also provides support for a method, comprising: executing a closed clutch cleaning operation in response to clutch engagement in lockup torque control exceeding a first threshold duration and a clutch pressure demand within a threshold pressure range comprising sending a valve cleaning control pulse to a valve, discontinuing the closed clutch cleaning operation in response to detecting at least one exit condition, and setting a delay timer in response to the valve cleaning control pulse exceeding a second threshold duration. In a first example of the method, the at least one exit condition comprises at least one of a clutch disengagement is anticipated and the clutch pressure demand is outside of the threshold pressure range. In a second example of the method, optionally including the first example, the at least one exit condition comprises an oil temperature exceeding an upper threshold or decreasing below a lower threshold. In a third example of the method, optionally including one or both of the first and second examples, the at least one exit condition comprises detecting a component fault. In a fourth example of the method, optionally including one or more or each of the first through third examples, the clutch engagement in lockup torque control comprises a clutch torque demand above a current engine torque.

In another representation, a method comprises selecting from a plurality of cleaning operations a closed clutch cleaning operation in response to operating conditions indicating a clutch engagement in lockup torque control exceeding a threshold duration and a clutch pressure within a threshold pressure range, executing the closed cleaning operation while monitoring one or more exit conditions in response to selecting the clutch cleaning operation, and aborting the clutch cleaning operation in response to operating conditions indicating at least one of the one or more exit conditions.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

The invention claimed is:

1. A method, comprising:
sending a valve cleaning control pulse to a valve in response to a clutch persisting in an engaged position and a clutch pressure demand within a threshold pressure range; and
discontinuing the valve cleaning control pulse in response to detecting at least one exit condition.

2. The method of claim 1, wherein the at least one exit condition comprises at least one of a clutch disengagement is anticipated and the clutch pressure demand is outside of the threshold pressure range.

3. The method of claim 1, wherein the at least one exit condition comprises an oil temperature exceeding an upper threshold or reducing below a lower threshold.

4. The method of claim 1, wherein the at least one exit condition comprises detecting a component fault.

5. The method of claim 1, wherein the clutch persisting in the engaged position comprises a clutch torque demand above a current engine torque.

6. The method of claim 1, wherein the clutch comprises one of a first clutch mechanism and a second clutch mechanism of a dual-clutch transmission.

7. The method of claim 1, wherein the valve is a spool valve.

8. The method of claim 1, wherein the valve cleaning control pulse comprises cyclically adjusting a valve pressure between a first threshold and a second threshold for a second threshold duration.

9. The method of claim 8, further comprising:
discontinuing the valve cleaning control pulse in response to the valve cleaning control pulse exceeding the second threshold duration; and
setting a delay timer.

10. The method of claim 9, wherein the delay timer is set for 600 seconds.

11. A system, comprising:
a transmission configured to rotationally couple a prime mover to a drive shaft;
a first input shaft coupled to the transmission;
a second input shaft coupled to the transmission;
a dual-clutch assembly comprising a first clutch mechanism and a second clutch mechanism, the first clutch mechanism and the second clutch mechanism selectively coupling one of the first input shaft and the second input shaft, respectively, to the prime mover in response to a clutch pressure demand;
a valve configured to control a flow of hydraulic fluid to the dual-clutch assembly; and
a controller including non-transitory instructions stored in memory executable to:
send a valve cleaning control pulse to the valve in response to detection of one of the first clutch mechanism and the second clutch mechanism persisting in an engaged position for a first threshold duration and the clutch pressure demand within a threshold pressure range; and
discontinue the valve cleaning control pulse in response to detection of at least one exit condition.

12. The system of claim 11, wherein the valve is a spool valve.

13. The system of claim 11, wherein the first input shaft is an inner shaft and the second input shaft is an outer input shaft coaxial with the first input shaft.

14. The system of claim 11, wherein the at least one exit condition comprises at least one of clutch disengagement is anticipated and the clutch pressure demand is outside of the threshold pressure range.

15. The system of claim 11, wherein the valve cleaning control pulse comprises cyclically adjusting a valve pressure between a first threshold and a second threshold for a second threshold duration.

16. A method, comprising:
executing a closed clutch cleaning operation in response to clutch engagement in lockup torque control exceeding a first threshold duration and a clutch pressure demand within a threshold pressure range comprising sending a valve cleaning control pulse to a valve;
discontinuing the closed clutch cleaning operation in response to detecting at least one exit condition; and
setting a delay timer in response to the valve cleaning control pulse exceeding a second threshold duration.

17. The method of claim 16, wherein the at least one exit condition comprises at least one of a clutch disengagement is anticipated and the clutch pressure demand is outside of the threshold pressure range.

18. The method of claim 16, wherein the at least one exit condition comprises an oil temperature exceeding an upper threshold or decreasing below a lower threshold.

19. The method of claim 16, wherein the at least one exit condition comprises detecting a component fault.

20. The method of claim 16, wherein the clutch engagement in lockup torque control comprises a clutch torque demand above a current engine torque.
